(19) United States
(12) Patent Application Publication
(10) Pub. No.: US 2025/0362016 A1
(43) Pub. Date: Nov. 27, 2025

(54) COMBUSTION SYSTEM ABLE TO OPERATE WITH RECYCLING OF THE COMBUSTION GAS

(71) Applicant: CARBODOWN, NOMAIN (FR)

(72) Inventor: Jaouad Zemmouri, Nomain (FR)

(21) Appl. No.: 18/872,044

(22) PCT Filed: Jun. 5, 2023
(86) PCT No.: PCT/EP2023/065006

§ 371 Date: Dec. 5, 2024

(30) Foreign Application Priority Data
Jun. 9, 2022 (FR) 2205538
Nov. 3, 2022 (FR) 2211436

(51) Int. Cl. F23N 1/02; F23C 9/00; F23D 14/02; F23J 15/02; F23L 7/00

(52) U.S. Cl. CPC F23N 1/022; F23C 9/00; F23D 14/02; F23J 15/022; F23L 7/00; F23L 7/007; F23C 2202/10; F23C 2202/50; F23C 2900/09001; F23J 2215/10; F23J 2215/20; F23J 2215/50; F23N 2221/12; F23N 2225/00; F23N 2235/04; F23N 2235/06; F23N 2235/10; F23N 2237/20

(57) ABSTRACT

A combustion system including a bypass which opens to the open air during two different operating modes (“conventional combustion”; “oxy-combustion”), and which has the function, on the one hand, in the two operating modes, when the discharge valve is at least partially open and the recycling valve is closed or open, of allowing air to enter the recycling loop, and which has the function, on the other hand, in the second operating mode, when the discharge valve is closed and the recycling valve is open, of allowing a surplus of the combustion gas produced by the combustion device to be discharged from the recycling loop, the other fraction of the combustion gas produced by the combustion device supplying the mixer.

### CROSS-REFERENCE TO RELATED APPLICATIONS

This application is a Section 371 National Stage Application of International Application No. PCT/EP2023/065006, filed Jun. 5, 2023, and published as WO 2023/237496 on Dec. 14, 2023, not in English, which claims priority to French Patent Application Nos. FR2205538, filed Jun. 9, 2022, and FR 2211436, filed Nov. 3, 2022, the contents of which are incorporated herein by reference in their entireties.

### TECHNICAL FIELD

The present disclosure relates to the field of combustion with recycling of at least part of the combustion gas.

### PRIOR ART

So-called “conventional” combustion consists in mixing air (an oxidizer) in a combustion apparatus (furnace, boiler, etc.) with a fuel under high-temperature conditions to create oxidation. The reaction is exothermic and is naturally sustained. Air contains 21% molecular oxygen (O₂) and the volume of air used is controlled so that the amount of molecular oxygen is sufficient for combustion.

In conventional combustion, the combustion fumes comprise water vapor (H₂O) and combustion products in the gas phase, mainly molecular nitrogen (N₂) in the gas phase, and carbon dioxide (CO₂) in the gas phase.

In this text, the term “combustion gases” refers to the combustion products in the gas phase that are discharged after combustion.

If it is desired to capture the CO₂ from these fumes, it is easy to remove the water vapor by condensing these combustion fumes and collecting the water in liquid form. On the other hand, the main difficulty lies in separating the nitrogen and carbon dioxide. Furthermore, in conventional combustion, depending on the type of fuel used, the combustion gas may also comprise other polluting combustion products in the gas phase, in a greater or lesser amount, such as, for example, SOx (sulfur oxides), NOx (nitrogen oxides), HCl (hydrogen chloride), HF (hydrogen fluoride), etc. Consequently, if it is desired to capture the CO₂ from these fumes, it is also necessary to separate the CO₂ from these other pollutants.

Several solutions have been envisaged to capture the CO₂ from fumes from conventional combustion, but their cost remains very high.

In order to reduce the emission of pollutants in combustion fumes, it is known to replace the above-mentioned conventional combustion with combustion referred to as “oxy-combustion”, wherein the air (the oxidizer) is replaced with molecular oxygen in stoichiometric proportions, the number of oxygen atoms being equal to what is necessary to oxidize all the atoms of the fuel.

The production of molecular oxygen to implement oxy-combustion may for example be obtained in a known manner by cryogenics or by electrolysis of water.

In the case for example of oxy-combustion of methane (CH₄), combustion fumes are produced, consisting of ⅓ CO₂ in the gas phase and ⅔ water vapor by volume. In the case of other fuels, there will also be the pollutants resulting from combustion, such as HCl, SOx, etc. If the fuel does not contain nitrogen, advantageously the fumes will naturally not contain NOx.

The equation of the chemical reaction of the oxy-combustion of methane (CH₄) is as follows:

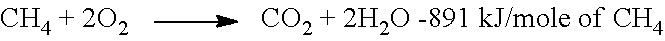

This means that each mole of CH₄ will outwardly produce an energy of 891 kJ.

For other fuels, the reactions are analogous, with the appearance of other compounds if the fuel contains atoms other than carbon and hydrogen.

In the case for example of oxy-combustion of methane, it is notably easier to capture the CO₂. To that end, it is sufficient to condense the water of the combustion fumes via a cooling or drying process to obtain CO₂ in the gas phase.

It is therefore currently known to implement a condenser for condensing the oxy-combustion fumes in order to facilitate the capture of CO₂.

A significant difficulty in oxy-combustion lies however in the difficulty of controlling combustion, since, unlike in conventional combustion, the oxy-combustion temperature can rapidly and uncontrollably become very high in the combustion chamber, to such a degree that conventional combustion apparatuses cannot withstand.

To overcome this difficulty, apparatuses have already been proposed which make it possible to improve oxy-combustion by condensing and recycling at least a part of the combustion gas comprising essentially CO₂ in the gas phase, so as to mix them with molecular oxygen and obtain an oxidizing gas (O₂—CO₂) which advantageously reduces the combustion temperature.

This improvement allows a molecular-oxygen-based oxy-combustion, with more easily controlled recycling of the combustion gas compared to oxy-combustion which uses only molecular oxygen as an oxidizer, while reducing the emission of pollutants compared to conventional combustion and facilitating the capture of CO₂.

These apparatuses are intended to operate solely in oxy-combustion with recycling of the combustion gas, which has a number of shortcomings.

The start-up and shut-down procedures for these apparatuses are critical and risky operating phases, and can lead detrimentally to uncontrolled, excessively high temperatures of oxy-combustion, with recycling of the combustion gas, in the combustion chamber.

During oxy-combustion, with recycling of the combustion gas, an excessive drop in the concentration of molecular oxygen in the oxidizing gas can lead detrimentally to an untimely halting of the combustion in the combustion chamber of the apparatus, which can have serious consequences, for example in an industrial production chain using the thermal energy produced.

International patent application WO 2011/148298 also proposed a combustion system with recycling of the combustion gas by means of a fan mounted on the recycling loop. This combustion system can operate either in conventional combustion with air supply, or in oxy-combustion with molecular oxygen supply and without air supply, with the fan mounted on the recycling loop operating in both cases. This publication further describes the implementation of a control unit, which is programmed to control, during a transitional period, the air supply rate and the molecular oxygen supply rate, so as to be able to switch from conventional combustion with air supply to oxy-combustion with molecular oxygen supply and without air supply, without interrupting the combustion process.

When the combustion system described in this publication operates in oxy-combustion mode, a malfunction of the molecular oxygen source can occur, resulting, for example, in an untimely and uncontrolled drop in the concentration of molecular oxygen in the oxidizing gas supplying the combustion chamber. This deficiency in molecular oxygen may have several, possibly cumulative causes: accidental interruption of the molecular oxygen supply due to an untimely halting of in situ molecular oxygen production or an empty source of molecular oxygen; an untimely slowdown of in situ molecular oxygen production; or an untimely drop in the flow rate or pressure of the molecular oxygen supply. However, an excessive drop in the concentration of molecular oxygen in the oxidizing gas, may lead detrimentally to an untimely halting of oxy-combustion.

The technical solution described in international patent application WO 2011/148298 has the disadvantage of not being able to automatically adapt its operation in the event of an untimely deficiency in molecular oxygen.

Furthermore, in the above-mentioned combustion system, when it is sought to stress the combustion chamber to provide more thermal energy during oxy-combustion, there is a risk of reaching uncontrolled and excessively high temperatures in the combustion chamber, and causing risks of explosion. Conversely, when it is sought to reduce the amount of thermal energy from the combustion chamber during oxy-combustion, there is a risk of causing an untimely halting of the combustion.

### SUMMARY

An aspect of the present disclosure thus relates to a combustion system comprising a combustion device allowing the combustion of a fuel by means of at least one oxidizing gas, a unit for supplying oxidizing gas which is connected to the combustion device and comprises a mixer, and a source of molecular oxygen gas which supplies an molecular-oxygen-rich gas and is connected to a first inlet of the mixer via a flow-control device of the molecular-oxygen-rich gas, recycling means comprising a recycling loop between the combustion device and a second inlet of the mixer, and a recycling valve mounted on the recycling loop, a first bypass on the recycling loop comprising a discharge valve, a second bypass on the recycling loop downstream of the first bypass and the recycling valve, and a control unit. The control unit is able to control the flow-control device of the molecular-oxygen-rich gas, the recycling valve and the discharge valve, so as to be able to configure the combustion system in an operating mode selected from at least two different operating modes (M1; M2) and to be able to switch from one operating mode to the other: a first operating mode (M1) wherein the recycling valve is closed, the discharge valve is open, and the mixer is not supplied with molecular-oxygen-rich gas from the source of molecular oxygen gas (the flow-control device being closed), and a second operating mode (M2), wherein the recycling valve is open and the discharge valve is at least partially open or closed, and the mixer is supplied at least with molecular-oxygen-rich gas supplied by the source of molecular oxygen gas (the flow-control device being open), and with at least a fraction of the combustion gas produced by the combustion device.

The second bypass opens to the open air during both operating modes (M1; M2), and has the function, on the one hand, in the two operating modes (M1; M2), when the discharge valve is at least partially open and the recycling valve is closed or open, of allowing air to enter the recycling loop in order to supply the second inlet of the mixer at least with incoming air, and on the other hand, in the second operating mode (M2), when the discharge valve is closed and the recycling valve is open, of allowing a surplus of the combustion gas produced by the combustion device to be discharged from the recycling loop, the other fraction of the combustion gas produced by the combustion device supplying the second inlet of the mixer.

The term “molecular-oxygen-rich gas” means that the gas contains at least 40% (percentage by volume) molecular oxygen.

In said first operating mode (M1), the mixer is supplied at least with air drawn from the ambient air via the second bypass and the combustion fumes emitted by the combustion device are discharged via the first bypass without being recycled.

As a result, the oxidizing gas contains at least air and no molecular oxygen from the source of molecular oxygen gas. Combustion in the combustion device is thus conventional combustion.

In this first operating mode and in one particular alternative embodiment, the oxidizing gas preferably consists solely of air.

In said second operating mode (M2), the oxidizing gas contains at least molecular-oxygen-rich gas from the source of molecular oxygen gas and at least a fraction of the recycled combustion gas.

As a result, combustion in the combustion device is oxy-combustion with recycling of the combustion gas.

More particularly, in said second operating mode (M2), in one particular operating phase, hereinafter referred to as “degraded oxy-combustion”, the oxidizing gas may comprise air, which has been drawn from the ambient air via the second bypass. In said second operating mode and in another particular operating phase hereinafter referred to as “enhanced oxy-combustion”, the oxidizing gas does not contain any air drawn from the ambient air via the second bypass.

In an aspect of the disclosure, the second bypass is a two-way bypass, thus acting as a passive safety device.

When the combustion system is in the first operating mode, the flow of incoming air drawn into the recycling loop via the second bypass adapts automatically, without any intervention in the combustion system. In particular, the flow rate of incoming air drawn into the recycling loop automatically adapts to the flow rate of the combustion gas produced by the combustion device, and if necessary automatically compensates for a change in the flow rate of this combustion gas. In the second operating mode with the discharge valve at least partially open (particular operating phase referred to as “degraded oxy-combustion”), the flow rate of incoming air drawn into the recycling loop via the second bypass automatically adapts to the flow rate of the combustion gas produced by the combustion device and to the flow rate of the molecular-oxygen-rich gas, and if necessary automatically compensates for a change in the flow rate of this combustion gas and/or a change in the flow rate of the molecular-oxygen-rich gas.

When the combustion system is in the second operating mode with the discharge valve closed (the operating phase referred to as “enhanced oxy-combustion”), any surplus combustion gas produced by the combustion device is discharged from the recycling loop, via the second bypass, at a flow rate that adapts automatically without any intervention in the combustion system. In particular, the flow rate of the surplus fraction of the combustion gas discharged from the recycling loop via the second bypass automatically adapts to the flow rate of the combustion gas produced by the combustion device and to the flow rate of the molecular-oxygen-rich gas, and if necessary automatically compensates for a change in the flow rate of this combustion gas and/or a change in the flow rate of the molecular-oxygen-rich gas.

More particularly, and especially in contrast to the solution described in international patent application WO 2011/148298, between the second bypass and the second inlet of the mixer (i.e. downstream of the second bypass), the recycling loop of the combustion system of an exemplary aspect of the disclosure is devoid of forced air circulation means, such as a fan or compressor, which forced air circulation means, by drawing air into the recycling loop via the second bypass, would prevent the discharge from the recycling loop, via the second bypass, of said surplus fraction of the combustion gas produced by the combustion device.

The combustion device can be a standard commercial combustion device or a special combustion device that has been specifically developed. This combustion device can have air inlets at different injection points according to combustion requirements. Advantageously, aspects of the disclosure can more particularly be implemented without the need for any modification to this combustion device.

More particularly, the combustion system according to an aspect of the disclosure can comprise the following additional and optional features, taken in isolation, or in combination with one another:
The flow-control device of molecular-oxygen-rich gas comprises a flow-control valve which is controlled by the control unit.
The flow-control valve is a progressive opening and closing valve.
The recycling valve is a progressive opening and closing valve and/or the discharge valve is a progressive opening and closing valve.
The combustion system comprises at least one sensor able to measure the concentration of molecular oxygen in the oxidizing gas, and the control unit is able to control the flow-control device of molecular-oxygen-rich gas according to the concentration of molecular oxygen measured by this sensor at least during the second operating mode (M2).
The combustion device comprises a fan or compressor able to supply the combustion device with oxidizing gas at a given flow rate, which is preferably variable.
The rate of supply of fuel to the combustion device is variable, and the combustion device comprises a fan or compressor able to supply the combustion device with oxidizing gas at a rate which varies according to the rate of supply of fuel to the combustion device.
The combustion system comprises a carbon dioxide injection device connected to an inlet of the mixer and adapted to inject carbon dioxide gas into the mixer during a particular operating phase, referred to as “degraded oxy-combustion”, of the second operating mode (M2).
The combustion system comprises on the recycling loop a condenser able to dehumidify the combustion fumes and to emit at the outlet a combustion gas, at least a fraction of which is recycled to the inlet of the mixer.
The combustion system comprises a condenser adapted to dehumidify the oxidizing gas prior to its introduction into the combustion device.
The condenser comprises at least one heat exchanger comprising a coolant liquid.
The exchanger comprises a bath of coolant liquid, and injection means making it possible to move the gaseous fluid to be dehumidified through this bath of coolant liquid, and preferably wherein the injection means make it possible to inject the gaseous fluid to be dehumidified below the surface of this bath of coolant liquid.
The combustion system comprises at least one sensor adapted to measure the concentration of molecular oxygen in the oxidizing gas, and wherein the control unit is adapted to control the flow-control device of molecular-oxygen-rich gas, the recycling valve and the discharge valve, so as to switch from the second operating mode to the first operating mode according to the measured concentration of molecular oxygen in the oxidizing gas.
The control unit is adapted to control the flow-control device of molecular-oxygen-rich gas, the recycling valve and the discharge valve, so as to be able to switch from one operating mode (M1 or M2) to the other (M2 or M1) without halting combustion in the combustion device.
The control unit is adapted to sequentially control the opening of the flow-control device of molecular-oxygen-rich gas, the opening of the recycling valve, and preferably the total or partial closing of the discharge valve, so as to switch from the first operating mode (M1) to the second operating mode (M2).
The control unit is adapted to sequentially control the opening of the discharge valve, the closing of the recycling valve, and the closing of the flow-control device of molecular-oxygen-rich gas, so as to switch from the second operating mode (M2) to the first operating mode (M1).
The combustion system comprises a carbon dioxide (CO₂) capture device adapted to capture carbon dioxide (CO₂) in at least a fraction of the combustion gas, when the combustion system is operating in the second operating mode (M2).
The molecular-oxygen-rich gas supplied by the source of molecular oxygen gas comprises at least 50% molecular oxygen, preferably at least 80% molecular oxygen, and even more preferably at least 90% molecular oxygen.
The molecular-oxygen-rich gas supplied by the source of molecular oxygen gas is pure or near-pure molecular oxygen (at least 99% O₂).
The combustion system comprises a pollution-removing device mounted on the recycling loop and adapted to capture one or more pollutants selected from the following list: fine particles, SOx, NOx, acids, heavy metals, ammonia, VOCs.

### BRIEF DESCRIPTION OF THE FIGURES

The features and advantages of the disclosure will become more clearly apparent on reading the detailed description below of several particular alternative embodiments, which particular alternative embodiments are described by way of non-limiting and non-exhaustive examples of the disclosure, and with reference to the appended drawings, in which:

FIG. 1 is a schematic depiction of a first particular alternative embodiment of a combustion system of the disclosure.

FIG. 2 depicts the combustion system of FIG. 1 in the first operating mode M1 (“conventional combustion”);

FIG. 3 depicts the combustion system of FIG. 1 in the second operating mode M2 (“oxy-combustion with recycling”) and in a particular operating phase (“degraded oxy-combustion”).

FIG. 4 depicts the combustion system of FIG. 1 in the second operating mode M2 (“oxy-combustion with recycling”) and in another particular operating phase (“enhanced oxy-combustion”).

FIGS. 5 to 10 are schematic depictions of five other particular alternative embodiments of a combustion system of the disclosure.

FIG. 11 depicts a particular example of a condenser that can be implemented in a combustion system of the disclosure.

### DETAILED DESCRIPTION

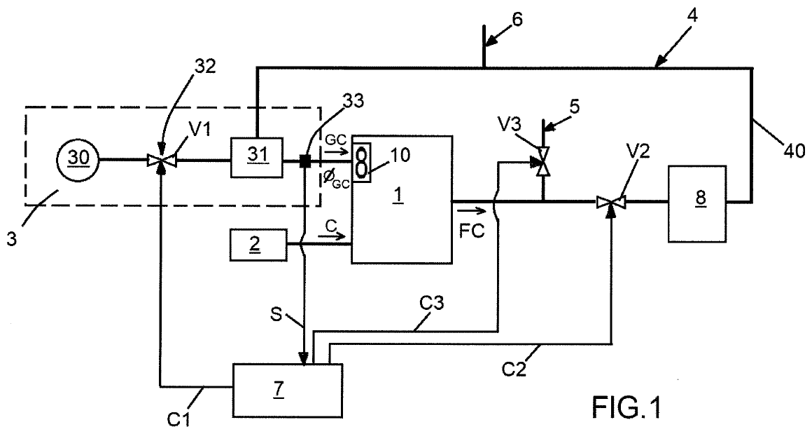

### Combustion System of FIG. 1

FIG. 1 schematically shows a first alternative embodiment of a combustion system of the disclosure comprising:
a combustion device 1, which is supplied with an oxidizing gas GC from a unit 3 for supplying oxidizing gas GC and with a fuel C from a fuel source 2 and which, during operation, emits combustion fumes FC;
recycling means 4, which comprise a recycling loop 40 between the outlet of the combustion device 1 and an inlet of the unit 3 for supplying oxidizing gas GC, and a recycling valve V2 mounted on the recycling loop 40;
a first bypass 5, which is connected to the recycling loop 40 and which comprises a discharge valve V3,
a second bypass 6, which is connected to the recycling loop 40, downstream of the first bypass 5 and the recycling valve V2, and which opens to the open air;
a control unit 7.

The combustion device 1 generally allows for oxy-combustion of the fuel C by means of said oxidizing gas GC, the thermal energy resulting from this combustion being able to be used interchangeably according to an aspect of the disclosure in any type of application requiring a heat supply, and for example and in a non-limiting manner to heat a fluid in a heating facility or to supply energy to an industrial production chain, especially thermal, mechanical or electrical. According to an aspect of the disclosure, this combustion device 1 can comprise a conventional boiler, a furnace or a combustion chamber in which a combustion process is implemented.

The combustion device 1 usually comprises a fan (or compressor) 10 that draws or pushes the oxidizing gas GC into the combustion apparatus 1, with automatic adjustment or regulation of the flow rate θ_{GC} of oxidizing gas GC entering combustion device 1 to adapt to the flow rate of fuel C and satisfy the needs for thermal energy.

The combustion device 1 can be a standard commercial combustion device or a special combustion device that has been specifically developed.

The combustion reaction of the fuel C by means of the oxidizing gas GC produces combustion fumes FC, the composition of which depends on the fuel C and the oxidizing gas GC.

In the context of the disclosure, the fuel C may be very different from one application to the next and may, depending on the case, be in solid, liquid or gaseous form.

The unit 3 for supplying oxidizing gas GC includes a source 30 of molecular oxygen gas (O₂) which supplies an inlet of a mixer 31, via a flow-control device 32 controlled by the control unit 7. The other inlet of the mixer 31 is connected to the recycling loop 40.

The source 30 of molecular oxygen gas supplies a molecular-oxygen-rich gas, i.e. a gas containing at least 40% (percentage by volume) molecular oxygen.

Preferably, as will be discussed hereinafter, the molecular-oxygen-rich gas can advantageously, but not necessarily, consist of pure or near-pure molecular oxygen (volume concentration greater than 90%).

The source 30 of molecular oxygen gas may be of any known type and may for example include a unit for producing molecular oxygen gas by cryogenics and/or a unit for producing molecular oxygen gas by electrolysis of water. The source 30 of molecular oxygen gas can also be a unit for producing molecular-oxygen-rich gas containing at least 40% molecular oxygen, obtained by suitable filtration of air using zeolites or the like. The source 30 of molecular oxygen gas may also not be designed to produce the molecular-oxygen-rich gas in situ, but may simply comprise a means for storing molecular-oxygen-rich gas that has been produced beforehand at another site.

In one alternative, the flow-control device 32 can simply make it possible to halt or allow the flow of molecular-oxygen-rich gas from the source 30. Preferably, however, this flow-control device 32 makes it possible to halt the flow of molecular-oxygen-rich gas from the source 30, or to allow the flow of molecular-oxygen-rich gas from the source 30, enabling the gas flow rate at the inlet of the mixer 31 to be adjusted by the control unit 7.

In the particular alternative embodiment of FIG. 1, the source 30 of molecular oxygen gas supplies, for example, the mixer 31 with a constant pressure, and the flow-control device 32 at the inlet of the mixer 31 comprises a valve V1, preferably a solenoid valve, which is controlled by the control unit 7.

Preferably, this valve V1 is a progressive opening and closing valve.

In another alternative, the flow-control device 32 at the inlet of the mixer 31 may also comprise a system for controlling the pressure of the gas at the outlet of the source 30, possibly associated with a valve which may be an on/off valve or a progressive opening and closing valve, the pressure control system and said valve being controlled by the control unit 7.

Preferably, the unit 3 for supplying oxidizing gas GC also includes at least one sensor 33, which measures the concentration of molecular oxygen in the oxidizing gas GC entering the combustion device 1 and delivers to the control unit 7 a signal S for measuring this concentration.

In the particular alternative embodiment of FIG. 1, the first bypass 5 is connected to the recycling loop 40 upstream of the valve V2. In the simplest case, the first bypass 5 may consist of a simple pipe fitted with a discharge valve V3 making it possible to control the flow of fluid circulating in said pipe.

The second bypass 6 is connected to the recycling loop 40 downstream of the valve V2.

In the particular alternative embodiment of FIG. 1, this second bypass 6 opens directly to the open air.

This second bypass 6 may consist of a simple pipe connected at one end to the recycling loop 40 and opening directly to the open air at its other end. In its simplest version, this second bypass 6 can also be a simple opening allowing the recycling loop 40 to communicate with the ambient air.

In another alternative embodiment, the second bypass 6 can also supply one or more cascade treatment devices for the combustion fumes FC that escape via this second bypass 6, and for example one or more pollution-removing devices one after another.

In the context of an aspect of the disclosure, the recycling valve V2 can be an on/off valve or, more preferably, a proportional opening and closing valve. Similarly, the discharge valve V3 can be an on/off valve or, more preferentially, a proportional opening and closing valve.

The valves V2 and V3 are preferably solenoid valves or pneumatic or hydraulic valves.

Preferably, in the alternative of FIG. 1, the combustion system comprises a condenser 8, which is mounted on the recycling loop 40, downstream of the first bypass 5 and upstream of the second bypass 6, and which is adapted to condense the combustion fumes FC emitted by the combustion apparatus 1 by cooling them, when the recycling valve V2 is open.

In the context of an aspect of the disclosure, this condenser 8 can generally comprise any type of heat exchanger enabling the combustion fumes FC to be cooled by any means so as to condense at least some of the water vapor contained in the combustion fumes F.

In the particular alternative of FIG. 1, the recycling valve V2 is mounted on the recycling loop 40 upstream of the condenser 8. In another alternative, the recycling valve V2 can be mounted on the recycling loop 40 after the condenser 8 (i.e. downstream of the condenser) and before the second bypass 6 (i.e. upstream of the second bypass 6).

The control unit 7 allows automatic control of the combustion system, and in this particular case the three valves V1, V2 and V3, by means of control signals C1, C2 and C3 respectively, so as to adapt the composition of the oxidizing gas GC and advantageously to allow the apparatus to operate in an operating mode selected from at least two different operating modes (M1 and M2) detailed hereinafter, and to switch from one operating mode (M1 or M2) to the other (M2 or M1).

This control unit 7 can be implemented in a variety of ways, for example by means of a programmable electronic control unit, such as a programmable logic controller, or a programmable electronic circuit including a microprocessor, a microcontroller or FPGA-type programmable logic circuits, or by means of a specific ASIC-type integrated electronic circuit.

### Combustion System Operating Modes

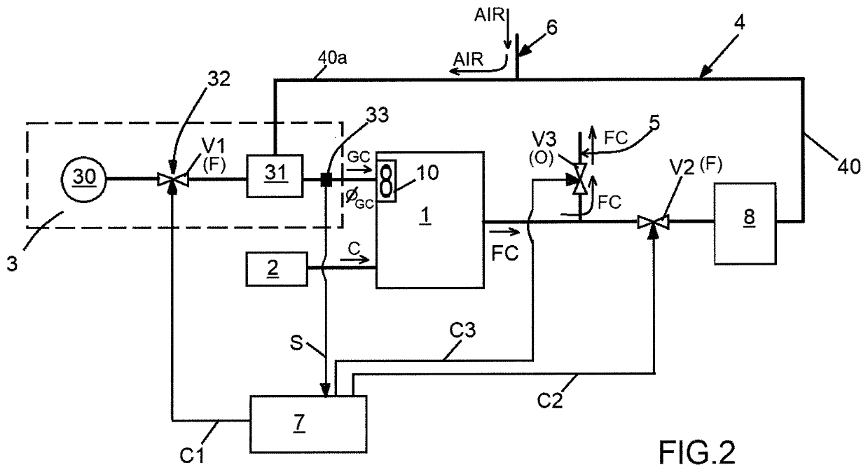

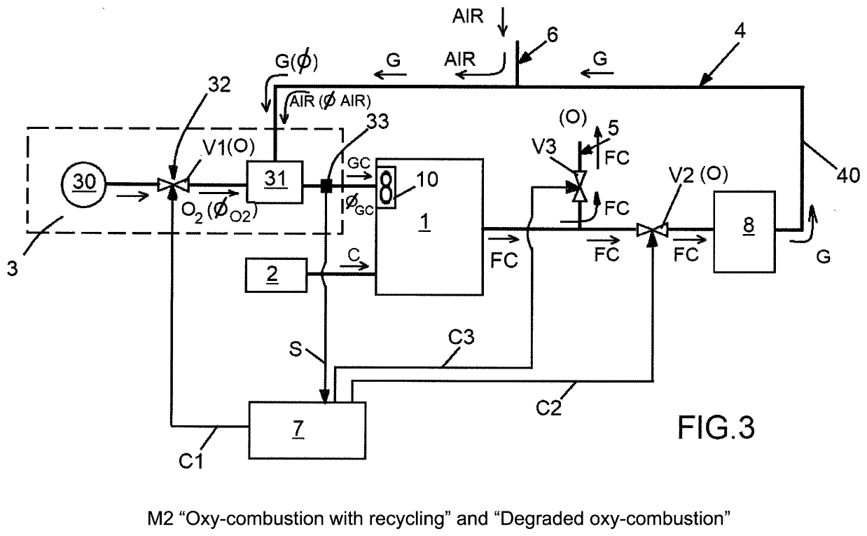

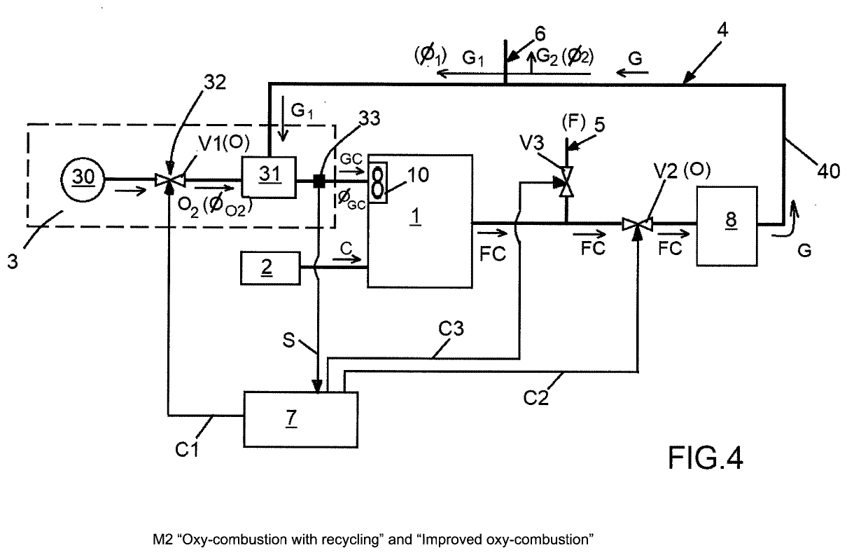

The combustion system of FIG. 1 can be configured by the control unit 7 to operate in at least two different main operating modes:
M1 (FIG. 2): an operating mode referred to as “conventional combustion”, wherein the valve V1 of the flow-control device 32 and the recycling valve V2 are closed (F) and the discharge valve V3 is open (O).
M2 (FIGS. 3 and 4): an operating mode referred to as “oxy-combustion with recycling”, wherein the valve V1 of the flow-control device 32 and the recycling valve V2 are open (O) and the discharge valve V3 is open (O) (totally or partially) or closed (F).

The transition from one operating mode (M1 or M2) to the other (M2 or M1) can be driven by the control unit 7 simply by appropriately controlling the flow-control device 32 (more specifically the valve V1), the recycling valve V2 and the discharge valve V3, and can advantageously be achieved without halting combustion in the combustion device 1 and without shutting down the combustion device 1.

### Operating Mode M1—“Conventional Combustion”—FIG. 2

In this operating mode, the valve V1 for supplying molecular oxygen from the source 30 and the recycling valve V2 have been closed (F) by the control unit 7. Only the discharge valve V3 is open (O).

The fan 10 (or compressor) of the combustion device 1 operates by imposing a variable flow rate θ_{GC} of oxidizing gas GC at the inlet of the combustion device 1.

The mixer 31 is not supplied with molecular oxygen from the source 30. The mixer 31 is supplied solely with air which is drawn from the ambient air via the second bypass 6 and which is conveyed to the inlet of the mixer 31, in the portion 40a of the recycling loop 40 which is downstream of the second bypass 6. Conventional combustion is thus performed in the combustion apparatus 1 by means of this air as oxidizing gas.

The combustion fumes FC do not recirculate to the mixer 31 (recycling valve V2 closed) but are discharged into the ambient air by being pushed by the fan (or compressor) 10 into the first bypass 5 (discharge valve V3 open).

Operating Mode M2—“Oxy—Combustion with Recycling”-FIGS. 3 and 4

In this operating mode, the valve V1 for supplying molecular oxygen from the source 30 and the recycling valve V2 have been opened (O) by the control unit 7. The discharge valve V3 is open (O) (totally or partially-FIG. 3) or closed (F) (FIG. 4).

The fan 10 (or compressor) of the combustion apparatus operates by imposing a variable flow rate (θ_{GC}) of oxidizing gas GC at the inlet of the combustion device 1.

This operating mode M2 comprises two operating phases:
a so-called “degraded oxy-combustion” operating phase, which is illustrated in FIG. 3,
a so-called “enhanced oxy-combustion” operating phase, illustrated in FIG. 4.

### Operating Phase of FIG. 3—“Degraded Oxy-Combustion”

A fraction of the combustion fumes FC exiting the combustion device 1 is discharged into the ambient air (discharge valve V3 at least partially open) and another fraction exiting the combustion device 1 is recycled in the recycling loop 40 (recycling valve V2 open) to the inlet of the condenser 8.

By passing through the condenser 8, the recycled combustion fumes FC are cooled and dehumidified by condensation of the water vapor present in the combustion fumes FC.

At the outlet of the condenser 8, a dehumidified combustion gas G is obtained, containing the combustion products in the gas phase produced by the combustion in the combustion device 1, and having an absolute humidity lower than that of the combustion fumes FC at the inlet of condenser 8.

The mixer 31 is supplied with molecular-oxygen-rich gas from the source 30 (valve V1 open) with a flow rate (θO₂) and is supplied with dehumidified combustion gas G at a flow rate θ.

The mixer 31 is also supplied with air which is drawn from the ambient air, via the second bypass 6, with an incoming flow rate of air θ_{AIR} and which is conveyed to the mixer 31, via the portion 40a of the recycling loop 40 which is downstream of the bypass 6, along with the dehumidified combustion gas G.

In operation: θ_{GC}=θO₂+θ+θ_{AIR}

This operating phase continues as long as the discharge valve V3 is not totally closed.

In this operating phase, the oxidizing gas GC contains molecular oxygen from the molecular-oxygen-rich gas supplied by the source 30, the recycled combustion gas G and air.

In this operating phase, when the flow rate θO₂ of molecular-oxygen-rich gas at the inlet of the mixer 31 increases and/or when the flow rate θ of the recycled combustion gas G at the inlet of the mixer 31 increases, the flow rate of air θ_{AIR} drawn into the second bypass 6 automatically decreases. Conversely, when the flow rate θO₂ of molecular-oxygen-rich gas at the inlet of the mixer 31 decreases and/or when the flow rate θ of the recycled combustion gas G at the inlet of the mixer 31 decreases, the flow rate of air θ_{AIR} drawn into the second bypass 6 automatically increases.

### Operating Phase of FIG. 4—“Enhanced Oxy-Combustion”

In this operating phase, the valve V1 for supplying molecular oxygen from the source 30 and the recycling valve V2 are open (O), and the discharge valve V3 is closed (F).

The combustion fumes FC exiting the combustion device 1 are not discharged into the ambient air through the closed discharge valve V3, but are recycled in the recycling loop 40 (recycling valve V2 open) to the inlet of the condenser 8 and are dehumidified by passing through the condenser 8.

In this operating phase, the mixer 31 is supplied with molecular oxygen from the molecular-oxygen-rich gas of the source 30 (valve V1 open) at a given flow rate (θO₂) and is supplied at a flow rate θ1 with a fraction G1 of the combustion gas G exiting the condenser 8; and the other surplus portion G2 of the combustion gas G exiting the condenser 8 is discharged to the open air at a flow rate θ2 by passing through the second bypass 6.

In operation:

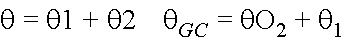

When the flow rate θO₂ of molecular-oxygen-rich gas at the inlet of the mixer 31 is increased, the flow rate θ₁ of the recycled fraction G1 of the combustion gas G automatically decreases, and when the flow rate θO₂ of molecular-oxygen-rich gas at the inlet of the mixer 31 is decreased, the flow rate θ₁ of the recycled fraction G1 of the combustion gas G automatically increases.

The oxidizing gas GC thus contains molecular oxygen from the molecular-oxygen-rich gas of the source 30 and the recycled fraction G1 of the combustion gas G.

Advantageously, the transition from the “degraded oxy-combustion” operating phase (valve V3 at least partially open) to the “enhanced oxy-combustion”operating phase (valve V3 closed) or vice versa can be achieved without having to shut down the combustion device 1 and without having to halt combustion in the combustion device 1.

Preferably, in the operating mode M2, the control unit 7 automatically regulates the flow rate θO₂ of molecular-oxygen-rich gas (e.g. by closing the valve V1 more or less) so that the concentration of molecular oxygen measured by the sensor 33 in the oxidizing gas GC is equal to or greater than a given operating setpoint or is within a given operating range. This enables the system to automatically adapt to variations in the flow rate θ_{GC} of oxidizing gas GC (imposed by the combustion device 1), maintaining an appropriate concentration of molecular oxygen O₂ in the oxidizing gas GC.

Especially, but by no means exclusively, the combustion system of FIG. 1 can be operated with a fuel C which, in the “enhanced oxy-combustion” operating phase, produces combustion fumes FC containing mainly carbon dioxide (CO₂) and water vapor (H₂O), and to a lesser extent molecular oxygen (O₂) and carbon monoxide (CO).

Thus, in a non-limiting and non-exhaustive manner, the fuel C used in the combustion system of FIG. 1 may advantageously be a hydrocarbon of any type, and for example a conventional hydrocarbon derived from oil or natural gas, or an unconventional hydrocarbon derived from shale gas or oil, bituminous shales or sands, coal gas, biogas, syngas, etc.

For example, when the fuel C is a saturated hydrocarbon of the alkane type (CₙH₂ₙ₊₂), the oxy-combustion reaction in the apparatus is, in a known manner:

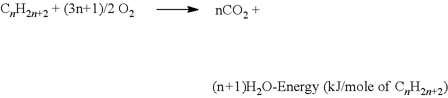

The fuel can also especially be a solid or liquid fuel obtained through extraction (coal, wood, etc.) or can include waste (plastics, salvage materials, etc.)

Recycling the combustion gas containing CO₂ to the inlet of the mixer 31 makes it possible, in a manner known per se, to better control the oxy-combustion reaction in the combustion device 1 and to significantly lower the combustion temperature in this combustion device 1, compared to an oxy-combustion reaction carried out solely or substantially using pure molecular oxygen as an oxidizer.

Various operating cases of the combustion system of FIG. 1 will now be described in detail.

Example of Control of the Combustion System to Switch from the Operating Mode M1 (“Conventional Combustion”) to the Operating Mode M2 (“Oxy-Combustion with Recycling”)

It is assumed that the combustion system is configured in the operating mode M1 (“conventional combustion”-FIG. 2), the molecular oxygen supply valve V1 and the recycling valve V2 having been closed (F) by the control unit 7, and only the discharge valve V3 is open (O).

The combustion apparatus 1 is in operation, the fan 10 (or compressor) of the combustion apparatus 1 imposing a given flow rate (θ_{GC}) of oxidizing gas GC consisting of air at the inlet to the apparatus 1.

To switch from this operating mode M1 (“conventional combustion”) to the operating mode M2 (“oxy-combustion with recycling”), the control unit 7 controls, preferably sequentially, the opening, preferably progressively, of the molecular oxygen supply valve V1, the opening, preferably progressively, of the recycling valve V2, and the total or partial closing, preferably progressively, of the discharge valve V3.

The combustion system thus switches to the operating mode M2 (“oxy-combustion with recycling”)

As long as the discharge valve V3 is not totally closed, the combustion system is in the operating phase referred to as “degraded oxy-combustion” (FIG. 3), previously described. The concentration of molecular oxygen in the oxidizing gas GC increases over time, while at the same time the concentration of air in the oxidizing gas decreases, the air being replaced by molecular oxygen. The combustion system can advantageously be operated without time limit in the operating mode M2 (“oxy-combustion with recycling”) and in said “degraded oxy-combustion” phase with partial air intake at least via the opening 6, and possibly via another secondary air intake, and partial discharge of the fumes FC via the bypass 5 or another partial outlet for the fumes FC.

When the discharge valve V3 is totally closed and when the sum (θO₂+θ) of the flow rate of molecular oxygen θO₂ and the flow rate θ of the combustion gas G becomes greater than the flow rate of oxidizing gas θ_{GC} imposed by the combustion apparatus 1, the combustion system automatically switches to the “enhanced oxy-combustion” operating phase (FIG. 4).

Preferably, when the combustion system has switched to the operating mode M2 (“oxy-combustion with recycling”), the control unit 7 automatically regulates the flow rate of molecular oxygen θO₂ (e.g. in this particular case by closing the progressive valve V1 more or less) using the measurement signal S of the concentration of molecular oxygen in the oxidizing gas G.

The switch from the operating mode M1 (“conventional combustion”) to the operating mode M2 (“oxy-combustion with recycling”) is simple and safe, avoiding the risks of an uncontrolled and untimely temperature rise in the combustion device 1. The switch from the operating mode M1 (“conventional combustion”) to the operating mode M2 (“oxy-combustion with recycling”) advantageously requires no intervention from the user on the combustion device 1 and, above all, does not require halting the combustion.

The switch from the operating mode M1 to the operating mode M2 (“oxy-combustion with recycling”), in the “degraded oxy-combustion” phase or in the “enhanced oxy-combustion” operating phase, can be requested from the control unit 7, at the initiative of the user of the combustion system, by means of a manual command to switch operating mode, for example.

The switch from the operating mode M1 to the operating mode M2 can also be implemented when the combustion system is started up in order to operate it in “oxy-combustion with recycling” mode (M2).

### Procedure for Starting Up the Combustion System

When a user seeks to start up the combustion system in order to operate it in “oxy-combustion with recycling” mode (M2), they request the control unit 7, by means of an appropriate command, to execute a start-up procedure.

The control unit 7 executes this start-up procedure by initially configuring the combustion system in operating mode M1 (“conventional combustion”).

The combustion device 1 is then started, especially by activating at least the fan (or compressor 10) of the combustion device 1, either manually by the user or automatically, for example by the control unit 7, which makes it possible initially to operate the system in conventional combustion mode (M1).

Then, in a second step, the control unit 7 controls the combustion system, so as to automatically switch to “oxy-combustion with recycling” mode (M2), as previously described, by choosing the operating phase referred to as “degraded oxy-combustion” or by totally closing the discharge valve V3 and increasing the flow rate θO₂ of molecular-oxygen-rich gas supplied by the source 30 until reaching the operating phase referred to as “enhanced oxy-combustion”.

Such a start-up phase is advantageously simple and safe. In particular, compared with a combustion system of the prior art that is adapted to operate solely in enhanced oxy-combustion mode, with recycling of the combustion gas, the risks of uncontrolled and untimely temperature rise, which are inherent in this type of apparatus of the prior art due to a high initial concentration of molecular oxygen in the oxidizing gas and a low initial concentration of CO₂, are avoided during the start-up phase.

Example of Control of the Combustion System to Switch from the Operating Mode M2 (“Oxy-Combustion with Recycling”) to the Operating Mode M1 (“Conventional Combustion”)

It is assumed that the combustion system is configured in the operating mode M2 (“oxy-combustion with recycling”), the molecular oxygen supply valve V1 and the recycling valve V2 having being opened (O) by the control unit 7, and the discharge valve V3 being at least partially open or being closed (F).

The combustion device 1 is in operation, the fan 10 (or compressor) of the combustion apparatus 1 imposing a given flow rate (θ_{GC}) of oxidizing gas GC consisting of air at the inlet to the apparatus 1.

To switch from this operating mode M2 (“oxy-combustion with recycling”) to the operating mode M1 (“conventional combustion”), the control unit 7 initially controls the total opening of the discharge valve V3, preferably progressively, while maintaining control of the oxygen level in the oxidizing gas GC by virtue of the valve V1, thus maintaining combustion and allowing the surplus combustion gas to be discharged to the outside. The bypass 6 makes it possible to supply external air or discharge the surplus combustion gas as required by the combustion device 1. Then, in a second step, once the opening of the valve V3 has been completed, the control unit 7 controls the closing of the recycling valve V2, preferably progressively, which makes it possible to prevent the recirculation of the combustion gas to the inlet of the mixer 31. Once the closing of the valve V2 has been completed, the control unit 7 controls the closing of the molecular oxygen supply valve V1, preferably progressively, which makes it possible to prevent the injection of molecular-oxygen-rich gas (supplied by the source 30) into the oxidizing gas GC and to switch the combustion system to “conventional combustion” (M1).

Alternatively, the closing of the molecular oxygen supply valve V1 and the closing of the recycling valve V2 can be controlled simultaneously by the control unit 7.

Alternatively, the opening of the discharge valve V3, the closing of the molecular oxygen supply valve V1 and the closing of the recycling valve V2 do not need to be sequential, but can be controlled simultaneously by the control unit 7.

The switch from the operating mode M2 (“oxy-combustion with recycling”) to the operating mode M1 (“conventional combustion”) is simple and safe, avoiding the risks of an uncontrolled and untimely temperature rise in the combustion apparatus 1. The switch from the operating mode M2 (“oxy-combustion with recycling”) to the operating mode M1 (“conventional combustion”) advantageously requires no intervention from the user on the combustion device 1 and, above all, does not require halting the combustion.

The switch from the operating mode M2 to the operating mode M1 can be requested from the control unit 7, at the initiative of the user of the combustion system, by means of a manual command to switch operating mode, for example.

The switch from the operating mode M2 to the operating mode M1 can also be implemented during a procedure for shutting down the operation of the combustion system.

### Procedure for Shutting Down the Combustion System

When a user seeks to shut down the combustion system while it is operating in “oxy-combustion with recycling” mode (M2), they request the control unit 7, by means of an appropriate command, to execute a shut-down procedure.

The control unit 7 executes this shut-down procedure by controlling the flow-control device 32 of molecular-oxygen-rich gas, the valve V3 and the valve V2 as previously described (switch from the operating mode M2 to the operating mode M1).

Once the combustion system is configured in this operating mode M1 (“conventional oxy-combustion”), the combustion device 1 can be shut down conventionally without incurring any risk.

Such a shut-down phase is advantageously simple and safe. In particular, compared with a combustion system of the prior art that is adapted to operate solely in oxy-combustion with recycling of the combustion gas, the risks of uncontrolled and untimely temperature rise, which are inherent in this type of apparatus of the prior art, are avoided during the shut-down phase.

The switch from the operating mode M2 to the operating mode M1 can also be implemented when the concentration of molecular oxygen (supplied by the source 30) in the oxidizing gas GC becomes insufficient and no longer allows enhanced oxy-combustion with recycling of the combustion gas.

This insufficiency may have several, possibly cumulative, causes.

It may happen, for example, that during operation of the combustion system in the operating mode M2 (“oxy-combustion with recycling”), and especially in the “enhanced oxy-combustion” operating phase, an accidental interruption of the molecular oxygen supply occurs, for example due to an untimely halting of the in situ production of molecular-oxygen-rich gas by the source 30 or a source 30 of molecular-oxygen-rich gas that is empty.

It may happen, for example, that during operation of the combustion system in the operating mode M2 (“oxy-combustion with recycling”), and especially in the “enhanced oxy-combustion” operating phase, the molecular oxygen supply decreases too significantly, for example as a result of an untimely slowdown of the in situ production of molecular-oxygen-rich gas by the source 30 or an excessively low pressure in the source 30.

It may happen, for example, that during operation of the combustion system in the operating mode M2 (“oxy-combustion with recycling”), and especially in the “enhanced oxy-combustion” operating phase, the combustion device 1 is called upon to supply more thermal energy, and in response increases the flow rate θ_{GC} (increasing the flow rate of the fan or compressor 10) of oxidizing gas GC. In this case, the remaining oxidizing gas is automatically injected through the second bypass 6.

If the combustion device 1 reduces the supply of thermal energy, which results in a reduction in the need for the oxidizing gas GC, the surplus oxidizing gas is discharged via the bypass 6, and the control system 7 adjusts the valve V1, if necessary, in order to reduce the injection of molecular oxygen into the mixer 31.

In a conventional apparatus able to operate only in oxy-combustion, with recycling of the combustion gas, an excessive drop in the concentration of molecular oxygen in the oxidizing gas GC can lead to an untimely halting of the oxy-combustion.

Such an untimely halting can advantageously be avoided by means of the combustion system of an aspect of the disclosure.

To this end, the control unit 7 is preferably designed to monitor, by means of the sensor 33, the concentration of molecular oxygen in the oxidizing gas GC, and when the concentration of molecular oxygen decreases, to automatically detect whether this concentration of molecular oxygen reaches a predefined and preferably parameterizable critical minimum threshold, and if so, to automatically control the combustion system, so as to switch it (as previously described) safely to the operating mode M1 (“conventional combustion”), without halting combustion in the combustion device 1.

Further non-exhaustive examples of combustion systems in accordance with the disclosure that are capable of operating in the operating modes M1 (“conventional combustion”) and M2 (“combustion with recycling”) will now be described.

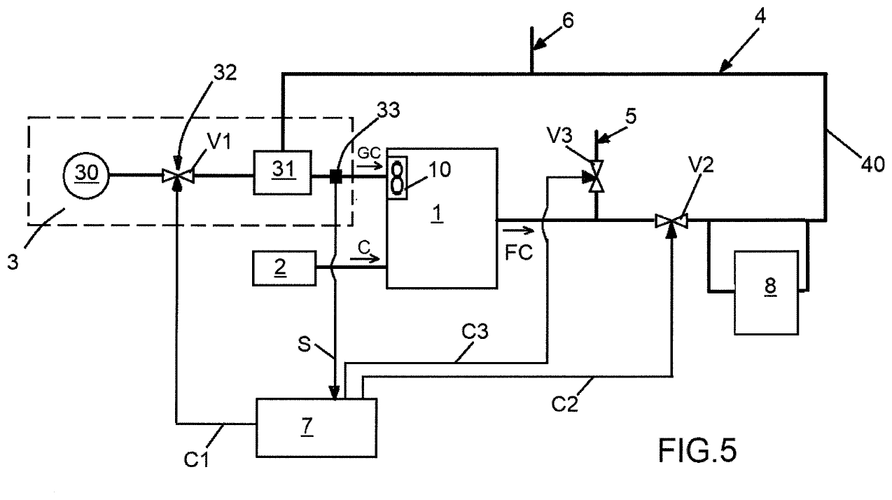

### Combustion System of FIG. 5—Condenser 8 in Bypass Mode

The combustion system of FIG. 5 differs from that of FIG. 1 in that the condenser 8 is mounted as a bypass on the recycling loop 40.

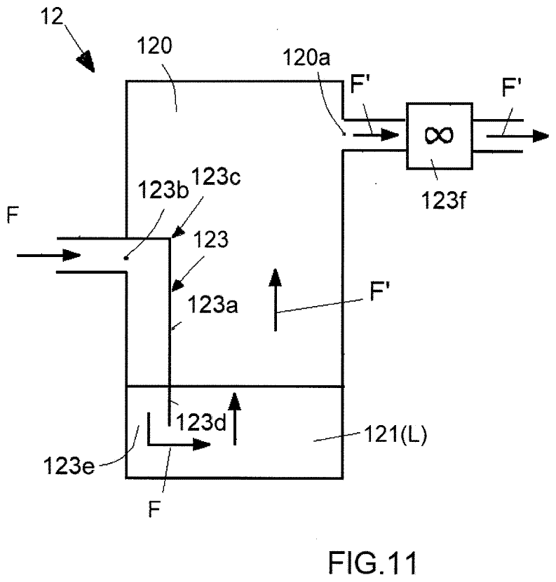

This type of mounting is suitable in a known manner for the condensers 8, which have their own fan or compressor, such as that described hereinafter with reference to FIG. 11. The explanations given previously on the operation of the combustion system of FIG. 1 also apply to this combustion system of FIG. 5.

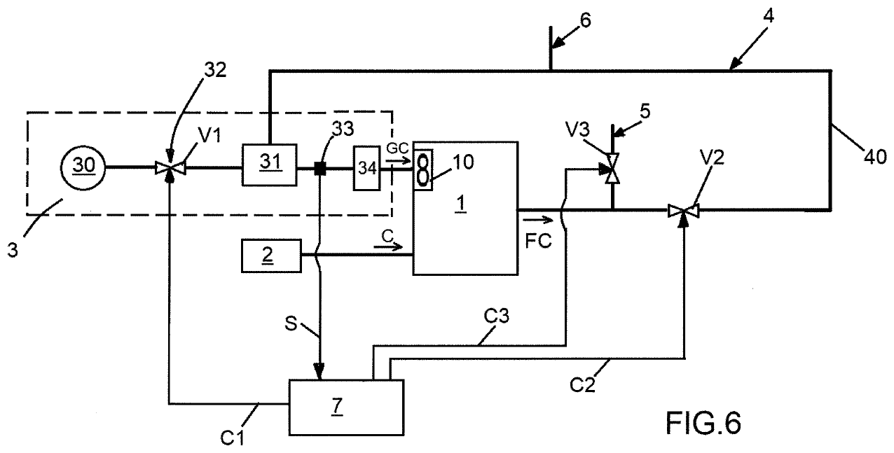

### Combustion System of FIG. 6—Condenser 34 Downstream of the Mixer 31

The combustion system of FIG. 6 differs from that of FIG. 1 in that the condenser 8 has been replaced by a condenser 34, which is supplied at the inlet by the mixer 31 and is connected at the outlet to the combustion device 1 and supplies the combustion device 1 with the oxidizing gas GC.

In this alternative, when the valve V2 is open and the combustion system is in the operating mode M2 (“oxy-combustion with recycling”), the combustion fumes FC are recycled to the mixer 31 without having been dehumidified, dehumidification being performed by the condenser 34.

In another alternative, the condenser 34 can be mounted as a bypass, like the condenser 8 in FIG. 5.

In another alternative, the combustion system can comprise the condenser 8 upstream of the mixer 31 and the condenser 34 downstream of the mixer 31.

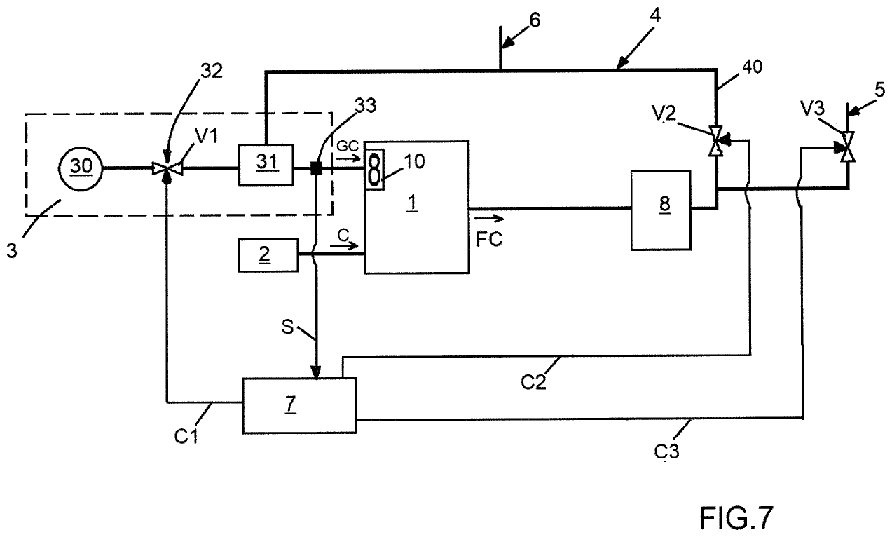

Combustion System of FIG. 7—Position of the Valves V2 and V3 after the Condenser 8

The combustion system of FIG. 7 differs from that of FIG. 1 in that the recycling valve V2 and the first bypass 5 comprising the discharge valve V3 are connected to the recycling loop 40 downstream of the condenser 8. In this configuration, the condenser 8 is used in the two operating modes M1 and M2.

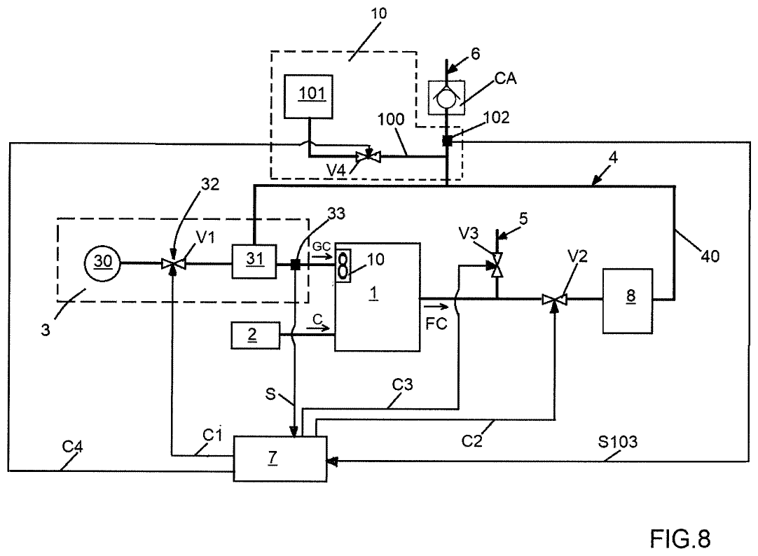

### Combustion System of FIG. 8—CO₂ Capture

The combustion system of FIG. 8 differs from that of FIG. 1 in that it comprises an additional CO₂ capture device 10, that is adapted to operate when the combustion system is operating in the mode M2 (“oxy-combustion with recycling”) and in the “enhanced oxy-combustion” phase.

This device 10 comprises, for example, a CO₂ capture unit 101, a bypass 100 which connects the CO₂ capture unit 101 to the second bypass 6, a valve V4 which is mounted on the bypass 100 and which is controlled by the control unit 7 by means of a control signal C4, and a sensor 102 which detects the direction of circulation of the gaseous fluid in the second bypass 6 and delivers a detection signal S103 to the control unit 7. The device 10 may also include a fan or compressor that makes it possible to draw in combustion gas circulating through the second bypass 6.

The second bypass 6 is equipped with an adjustable check valve CA, which allows a gaseous fluid (in this case air) to pass freely through the second bypass 6 in one direction from the outside (ambient air) to the inside of the bypass 6, and which is adjustable or controlled by the control unit 7 so as to restrict the flow of a gaseous fluid in the opposite direction, or which is adjustable or controlled by the control unit 7 so as to block the flow of a gaseous fluid in the opposite direction, when the return pressure in the second bypass 6 is greater than a predefined pressure.

When the combustion system is in the first operating mode M1, as well as in the phase (“degraded oxy-combustion”) of the second operating mode M2, the valve V4 is closed and the check valve CA allows air from the outside into the second bypass 6 and into the recycling loop 40 until the mixer 31.

When the combustion system switches to the mode M2 (“oxy-combustion with recycling”) and to the “enhanced oxy-combustion” phase, the sensor 102 detects the change in the direction of circulation of the gaseous fluid due to the escape of the combustion gas G2 into the second bypass 6, and the control unit 7 automatically controls the opening of the valve V4, thereby supplying the CO₂ capture unit 101 with all or part of the combustion gas G2 that escapes from the recycling loop 40 into the second bypass 6. During this phase, the check valve CA blocks or restricts the flow of combustion gas to the open air outlet of the second bypass 6.

When the combustion system exits the “enhanced oxy-combustion” phase and enters the transitional phase (“degraded oxy-combustion”), the sensor 102 detects the change in the direction of circulation of the gaseous fluid due to air being drawn into the second bypass 6, and the control unit 7 automatically controls the closing of the valve V4.

This CO₂ capture device 10 can also be added to the combustion system of FIGS. 5 to 7, 9 and 10.

In another alternative, the CO₂ capture device can be mounted on the recycling loop 40 between the first bypass 5 and the second bypass 6, and is activated by the control unit 7 when the direction of circulation of gaseous fluid in the bypass 6 is outwards.

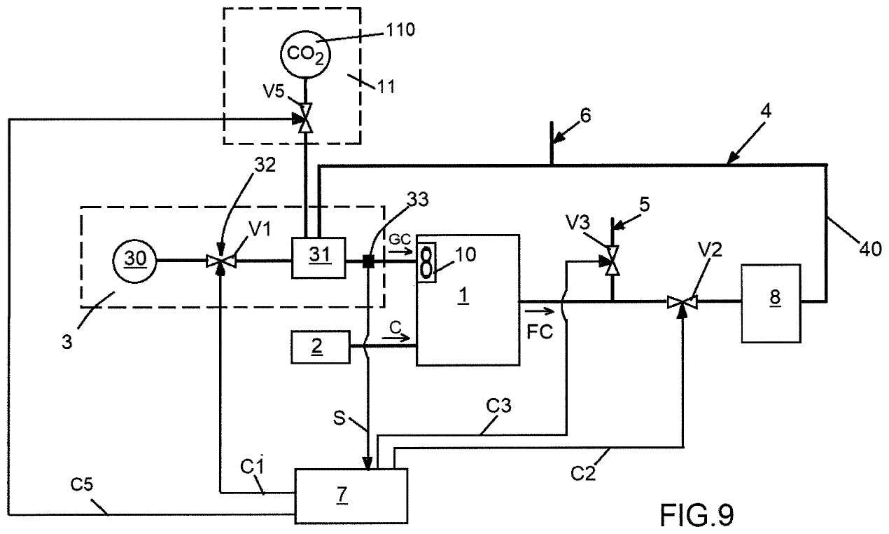

### Combustion System of FIG. 9—CO₂ Injection on Start-Up

The combustion system of FIG. 9 differs from that of FIG. 1 in that it comprises an additional device 11 connected to an inlet of the mixer 31 for injecting carbon dioxide gas (CO₂) into the mixer 31 during the “degraded oxy-combustion” transitional phase when switching from the second operating mode M2 in the “degraded oxy-combustion” phase to the second operating mode M2 in the “enhanced oxy-combustion” phase, in order to shorten the duration of this transitional phase.

This CO₂ injection device 11 comprises, for example, a source 110 of pressurized CO₂ gas associated with a valve V5 controlled by the control unit 7 by means of a control signal C5.

This CO₂ injection device 11 can also be added to the combustion system of FIGS. 5 to 8 and 10.

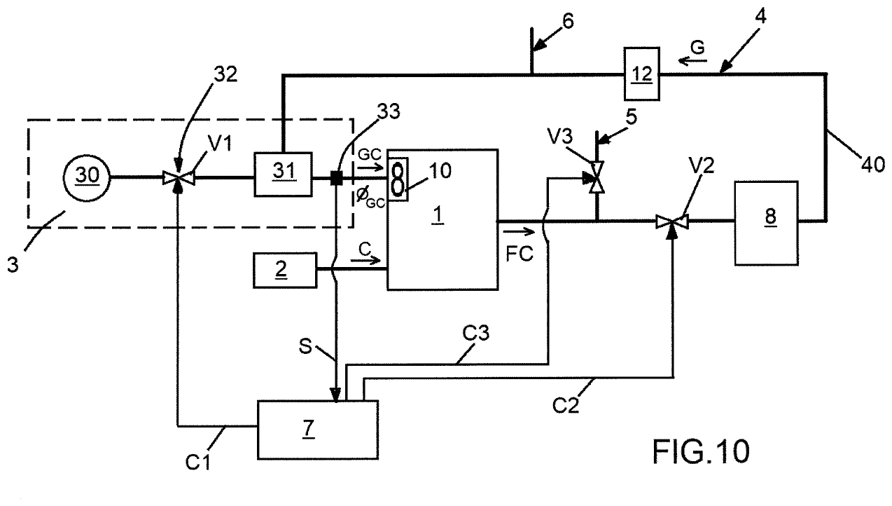

### Combustion System of FIG. 10—Pollution-Removing Device 12

The combustion system of FIG. 10 differs from that of FIG. 1 in that it comprises at least one pollution-removing device 12 (known per se) mounted on the recycling loop 40 and adapted to capture, in the combustion gas circulating through the recycling loop 40, one or more pollutants selected from the following list: fine particles, SOx, NOx, acids, heavy metals, ammonia, VOCs.

As shown in FIG. 10, this pollution-removing device 12 is preferably mounted upstream of the second bypass 6. However, it can also be mounted between the bypass 6 and the mixer 31.

This pollution-removing device 12 can also be added to the combustion system of FIGS. 5 to 9.

### Specific Example of a Condenser—FIG. 11

As a non-limiting example of the disclosure, FIG. 11 depicts a preferred example of a condenser that can be used as a condenser in the combustion system of the disclosure, in particular as a condenser 8 or 34 being mounted as a bypass.

This condenser comprises an exchanger 12, which includes an enclosure 120 containing a bath 121 of coolant liquid L and injection means 123, which are adapted to introduce the gaseous fluid F to be dehumidified (i.e. combustion fumes FC for the alternatives of FIGS. 1 to 5 and 7 to 10 or combustion gases exiting the mixer 31 for the alternative of FIG. 6) below the surface of the bath of coolant liquid L.

The coolant liquid L may simply be water or an aqueous solution.

These injection means 123 may more particularly comprise a fan or compressor 123f and an injection duct 123a comprising an intake opening 123b, for example in its upper part 123c. The lower part 123d of the injection duct 123a is immersed in the bath 121 of coolant liquid L and comprises a discharge opening 123e immersed in the bath 121 of coolant liquid L.

In operation, the fan or compressor 123f makes it possible to draw in the gaseous fluid F to be dehumidified (i.e. combustion fumes FC for the alternatives of FIGS. 1 to 5 and 7 to 10, or combustion gases exiting the mixer 31 for the alternative of FIG. 6) and introduce it into the injection duct 123 via the inlet opening 123b. This gaseous fluid F escapes from the injection duct 123 via the discharge opening 123e, and is thereby introduced forcibly into the bath 121 of coolant liquid L, below the surface of the bath 121 of coolant liquid L, rises to the surface of the bath of liquid, and escapes from the enclosure 120 via the discharge opening 120a of the enclosure 120 after having been dehumidified in the form of a dehumidified gas F′.

The temperature T_{L} of the coolant liquid L is always less than the temperature T_{F} of the gaseous fluid F at the inlet of the exchanger 12 and is preferably less than the dew temperature (dew point) of the gaseous fluid F.

It is noted that the absolute humidity (g_{water}/kg_{dry air}] of a gas represents the number of grams of water vapor present in a given volume of gas, relative to the mass of dry gas in that volume expressed in kilograms. Its value remains constant even if the temperature of the gas varies, though while remaining greater than the dew point of the gas.

While passing through the bath 121 of coolant liquid L, the gaseous fluid F undergoes condensation when in contact with the coolant liquid L, so that the absolute humidity of the gas F′, at the outlet of the exchanger 12, is less than the absolute humidity of the gaseous fluid F at the inlet of the exchanger 12.

The difference between the absolute humidity of the dehumidified gas F′ and the absolute humidity of the incoming gaseous fluid F depends especially on the difference between the temperature T_{F} of the incoming gaseous fluid F and the lower temperature T_{L} of the coolant liquid L. The greater the temperature difference ΔT (ΔT=T_{F}−T_{L}) between the temperature T_{F} of the incoming gaseous fluid F and the temperature T_{L} of the coolant liquid L, the lower the absolute humidity of the dehumidified gas F′ is compared to the absolute humidity of the incoming gaseous fluid F.

In another alternative, the fan or compressor 123f can be connected to the injection duct 123 and used to introduce the gaseous fluid F into this injection duct 123 by blowing it through the intake opening 123b of this injection duct 123.

In particular, the exchanger 12 can be coupled to a heat pump (not shown), which makes it possible to renew the liquid L in the bath by extracting heat energy from it so as to maintain the temperature of this liquid at a sufficiently low level.

In another alternative embodiment, the condenser may comprise a plurality of exchangers 12 mounted one after another.

The disclosure is not limited to the use of an exchanger 12 of the type of FIG. 11. In other alternative embodiments, the exchanger 12 for the condensation of the gaseous fluid F may for example be of the type described in international patent application WO 2016/071648 or in international patent application WO 2020/030419 or may be an exchanger operating by spraying the coolant liquid L so that it comes into contact with the gaseous fluid F.

The disclosure is not limited to an exchanger operating with a coolant liquid, but can be implemented with any other known type of exchanger enabling dehumidification of a gaseous fluid.

Advantage of Using Molecular-Oxygen-Rich Gas Combined with Recirculation of at Least One Fraction of the Combustion Fumes

In the case of conventional combustion, for an amount Qd of fuel C to be burned per hour, a flow rate D of oxidizing air is used at the inlet to the combustion device. After combustion, combustion fumes are discharged at a flow rate of X. These fumes must be treated to comply with discharge standards for dust and chemicals. The larger X, the higher the cost of treating the combustion fumes.

In conventional combustion, the flow rate of air D (D<X) at the inlet to the combustion device is defined according to the oxygen needs for combustion and the management of the combustion device (e.g. flame management in the combustion chamber).

In conventional combustion, the combustion fumes contain:
nitrogen dioxide (N₂) with almost the same content by mass as the oxidizing air,
carbon dioxide (CO₂) resulting from combustion,
water from the combustion and, where applicable, from the evaporation of water that may be contained in the fuel (e.g. when the fuel consists of waste or coal) and water resulting from the oxidizing air,
molecular oxygen (O₂) that did not participate in the combustion
pollutants, depending on the fuel used, which may include fine particles, acids, NOx, SOx, heavy metals, dioxins, etc.

When the combustion system of an aspect of the disclosure operates in “oxy-combustion” mode as previously described (addition of molecular-oxygen-rich gas containing at least 40% O₂ with recirculation of a fraction of the combustion fumes), the flow rate of combustion fumes exiting the combustion device which are not recycled and which are discharged directly into the atmosphere and/or which are treated (e.g. for CO₂ capture) before discharge into the atmosphere is advantageously lower than the above-mentioned flow rate X.

The greater the fraction of O₂ in the molecular-oxygen-rich gas supplied by the source 30, the lower the flow rate of the combustion fumes that are not recycled and are discharged.

For example, when the molecular-oxygen-rich gas is pure molecular oxygen, it is possible in practice to recycle the combustion fumes with a high recycling flow rate of up to 10/11 of X and to discharge the rest of the combustion fumes, with a flow rate that is advantageously lower and may be of the order of 1/11 of X, either directly into the atmosphere, or by previously treating them, for example in order to capture the CO₂, before discharging them into the atmosphere and/or by removing pollution from them.

In another alternative embodiment of the disclosure, the mixer 31 may comprise an additional air inlet and/or the combustion device may comprise an additional air inlet for injecting additional air into the combustion in addition to the recycled combustion fumes and in addition to the molecular-oxygen-rich gas. This will simply have an effect on the above-mentioned coefficient of 11, which in this case will be between 1 and 11 depending on the additional air flow injected into the combustion via said additional air inlet.

When the molecular-oxygen-rich gas contains 90% molecular oxygen, it is possible in practice to recycle the combustion fumes with a high recycling rate of up to 9/10 of X and to discharge the rest of the combustion fumes, with a flow rate that is advantageously lower and may be of the order of 1/10 of X, either directly into the atmosphere, or by previously treating them, for example in order to capture the CO₂, before discharging them into the atmosphere and/or by removing the pollution from them, etc.

It should be emphasized that the constraints on the pollution of the oxidizing gas entering the combustion device are less than the environmental constraints linked to the pollution of non-recycled combustion fumes, which are increasingly stringent. According to the case, the recycled combustion fumes may therefore be left untreated, or the recycled combustion fumes may be treated before entering the mixer, which is “light” and much less costly than treating the non-recycled fumes. The total cost of treating the combustion fumes can therefore advantageously be significantly reduced.

In return for this significant reduction in the cost of treating the combustion fumes, the production of molecular-oxygen-rich gas incurs an additional operating cost, which in practice increases with the fraction of O₂ in the molecular-oxygen-rich gas, but which in practice remains significantly lower than the cost of treating the combustion fumes. It is therefore up to the skilled person to adapt and find a compromise on a case-by-case basis between the cost of producing gas that is more or less molecular-oxygen-rich and the cost of treating the combustion fumes.

In the context of an aspect of the disclosure, the molecular-oxygen-rich gas contains at least 40% molecular oxygen (below this threshold, the reduction in the flow rate of non-recycled combustion fumes is too small in practice). Preferably, the fraction of molecular oxygen gas in the molecular-oxygen-rich gas is at least 80%, more preferably at least 90%. More particularly, the molecular-oxygen-rich gas is advantageously pure or near-pure molecular oxygen gas (at least 99% O₂).

An exemplary aspect of the present disclosure therefore proposes a combustion system which can operate with recycling of at least part of the combustion gas, but which makes it possible to overcome all or some of the above-mentioned disadvantages inherent in the oxy-combustion apparatuses of the prior art that implement such recycling of the combustion gas.

Although the present disclosure has been described with reference to one or more examples, workers skilled in the art will recognize that changes may be made in form and detail without departing from the scope of the disclosure and/or the appended claims.

1. A combustion system comprising:
a combustion device for combustion of a fuel by using at least one oxidizing gas,
an oxidizing gas supply unit which is connected to the combustion device and which comprises a mixer and a source of molecular oxygen gas which supplies a molecular-oxygen-rich gas and is connected to a first inlet of the mixer via a device for controlling flow of the molecular-oxygen-rich gas,
a recycling loop between the combustion device and a second inlet of the mixer, and
a recycling valve mounted on the recycling loop, a first bypass on the recycling loop comprising a discharge valve, a second bypass on the recycling loop downstream of the first bypass and the recycling valve, and a control unit that is adapted to control the device for controlling the flow of molecular-oxygen-rich gas, the recycling valve and the discharge valve, so as to be able to configure the combustion system in an operating mode selected from at least two different operating modes and to be able to switch from one operating mode to the other, including:
a first operating mode wherein the recycling valve is closed, the discharge valve is open, and the mixer is not supplied with molecular-oxygen-rich gas from the source of molecular oxygen gas, and
a second operating mode, wherein the recycling valve is open and the discharge valve is at least partially open or is closed, and the mixer is supplied at least with molecular-oxygen-rich gas supplied by the source of molecular oxygen gas and with at least part of the combustion gas produced by the combustion device,
wherein the second bypass opens to the open air during both operating modes, and has a function in the two operating modes, when the discharge valve is at least partially open and the recycling valve is closed or open, of allowing air to enter the recycling loop in order to supply the second inlet of the mixer at least with incoming air, and has a function in the second operating mode, when the discharge valve is closed and the recycling valve is open, of allowing a surplus of the combustion gas produced by the combustion device to be discharged from the recycling loop, another fraction of the combustion gas produced by the combustion device supplying the second inlet of the mixer.

2. The combustion system according to claim 1, wherein the device for controlling the flow of molecular-oxygen-rich gas comprises a flow-control valve which is controlled by the control unit.

3. The combustion system according to claim 2, wherein the flow-control valve is a progressive opening and closing valve.

4. The combustion system according to claim 1, wherein the recycling valve is a progressive opening and closing valve and/or the discharge valve is a progressive opening and closing valve.

5. The combustion system according to claim 1, comprising at least one sensor adapted to measure concentration of molecular oxygen in the oxidizing gas and wherein the control unit is adapted to control the device for controlling the flow of molecular-oxygen-rich gas according to the concentration of molecular oxygen measured by this sensor at least during the second operating mode.

6. The combustion system according to claim 1, wherein the combustion device comprises a fan or compressor adapted to supply the combustion device with oxidizing gas at a given flow rate.

7. The combustion system according to claim 1, wherein a rate of supply of fuel to the combustion device is variable and the combustion device comprises a fan or compressor adapted to supply the combustion device with oxidizing gas at a rate, which varies according to the rate of supply of fuel to the combustion device.

8. The combustion system according to claim 1, comprising a carbon dioxide injection device connected to an inlet of the mixer and adapted to inject carbon dioxide gas into the mixer during a particular phase of the second operating mode.

9. The combustion system according to claim 1, comprising on the recycling loop a condenser adapted to dehumidify the combustion fumes and to emit at the outlet a combustion gas, at least a fraction of which is recycled to the inlet of the mixer.

10. The combustion system according to claim 1, comprising a condenser adapted to dehumidify the oxidizing gas prior to its introduction into the combustion device.

11. The combustion system according to claim 10, wherein the condenser comprises at least one exchanger comprising a coolant liquid.

12. The combustion system according to claim 10, wherein the at least one exchanger comprises a bath of coolant liquid, and an injector making it possible to move gaseous fluid to be dehumidified through this bath of coolant liquid.

13. The combustion system according to claim 1, comprising at least one sensor adapted to measure concentration of molecular oxygen in the oxidizing gas and wherein the control unit is adapted to control the device for controlling the flow of molecular-oxygen-rich gas, the recycling valve and the discharge valve, so as to switch from the second operating mode to the first operating mode according to the measured concentration of molecular oxygen in the oxidizing gas.

14. The combustion system according to claim 1, wherein the control unit is adapted to control the device for controlling the flow of molecular-oxygen-rich gas, the recycling valve and the discharge valve, so as to be able to switch from one operating mode to the other without halting combustion in the combustion device.

15. The combustion system according to claim 1, wherein the control unit is adapted to sequentially control opening of the device for controlling the flow of molecular-oxygen-rich gas and opening of the recycling valve.

16. The combustion system according to claim 1, wherein the control unit is adapted to sequentially control opening of the discharge valve, closing of the recycling valve, and closing of the device for controlling the flow of molecular-oxygen-rich gas, so as to switch from the second operating mode to the first operating mode.

17. The combustion system according to claim 1, comprising a carbon dioxide capture device adapted to capture carbon dioxide in at least a fraction of the combustion gas, when the combustion system is operating in the second operating mode.

18. The combustion system according to claim 1, comprising at least one pollution-removing device mounted on the recycling loop and adapted to capture one or more pollutants selected from the following list: fine particles, SOx, NOx, acids, heavy metals, ammonia, VOCs.

19. The combustion system according to claim 1, wherein the molecular-oxygen-rich gas supplied by the source of molecular oxygen gas comprises at least 50% molecular oxygen.

20. The combustion system according to claim 1, wherein the molecular-oxygen-rich gas supplied by the source of molecular oxygen gas is pure or near-pure molecular oxygen.
